(19) United States
(12) Patent Application Publication
(10) Pub. No.: US 2025/0233654 A1
(43) Pub. Date: Jul. 17, 2025

(54) ENHANCING FIELD OPERATION EFFICIENCY AND NETWORK PERFORMANCE USING FIBER SENSING AND GENERATIVE AI / LLM

(71) Applicant: NEC Laboratories America, Inc., Princeton, NJ (US)

(72) Inventors: Ming-Fang HUANG, Princeton, NJ (US); Tingfeng LI, Plainsboro, NJ (US); Shaobo HAN, Princeton, NJ (US); Ting WANG, West Windsor, NJ (US)

(73) Assignee: NEC Laboratories America, Inc., Princeton, NJ (US)

(21) Appl. No.: 19/030,328

(22) Filed: Jan. 17, 2025

Related U.S. Application Data
(60) Provisional application No. 63/621,812, filed on Jan. 17, 2024.

(51) Int. Cl. H04B 10/07; H04B 10/25

(52) U.S. Cl. CPC H04B 10/07; H04B 10/25

(57) ABSTRACT

Disclosed is an integrated distributed fiber optic sensing (DFOS) system and method employing generative Artificial Intelligence (AI) and Large Language Models (LLM) which advantageously enhances operational efficiency and network performance. Operational components include a Live Infrastructure Query, a Live Construction Query, and a Live Anomaly Query, which, collectively provide an interactive AI/LLM-driven set of solutions fused with fiber optic sensing technologies that effortlessly identify optical fiber cable anomalies in real-time, thereby mitigating optical fiber cable damage and providing real-time reports on maintenance activities on infrastructure facilities—including communications—and services built thereupon. Advantageous features include: i) live-updated database; ii) LLM system specifically for telecommunications networks; iii) Real-time response facilitation between field operations and infrastructure; iv) Comprehensive reporting capabilities—daily, weekly, monthly, and yearly; vi) Intelligent event-based recommendations for preventing fiber damage; and vii) Proactive suggestions derived from historical data for preemptive disaster prevention.

### CROSS-REFERENCE TO RELATED APPLICATIONS

This application claims the benefit of U.S. Provisional Patent Application Ser. No. 63/621,812 filed Jan. 17, 2024, the entire contents of which is incorporated by reference as if set forth at length herein.

### FIELD OF THE INVENTION

This application relates generally to optical communications networks. More particularly, it pertains to enhancing field operation efficiency and network performance using distributed fiber optic sensing (DFOS) systems, methods, structures along with generative artificial intelligence (AI) and large language models (LLM).

### BACKGROUND OF THE INVENTION

In the realm of high-speed data transmission and the imminent evolution of 5G and beyond networks, optical fiber stands as a quintessential cornerstone, playing a pivotal role in ensuring seamless connectivity. Notably, a novel wave of distributed fiber optic sensing technologies has been introduced to telecom facilities, harnessing the vary fiber that drives these networks as a multifaceted sensing medium. Consequently, an influx of invaluable sensing data is now being harvested from these networks, encompassing an array of parameters such as temperature, vibration, strain, and acoustic nuances.

Yet, amid this wealth of sensory information, a significant challenge arises for operators—the effective management and determination of pertinent insights from this deluge of sensing data. The intricate task of developing actionable intelligence from this diverse pool of sensor information presents itself as a formidable obstacle.

### SUMMARY OF THE INVENTION

An advance in the art is made according to aspects of the present disclosure directed to integrated DFOS systems, methods, and structures that employ generative Artificial Intelligence (AI) and Large Language Models (LLM) which advantageously enhance field operation efficiency and network performance.

Viewed from a first aspect, the present disclosure is directed to a Live Infrastructure Query (Live IQ). Viewed from a second aspect, the present disclosure is directed to a Live Construction Query (Live CQ). Viewed from a third aspect, the present disclosure is directed to a Live Anomaly Query (Live AQ).

These innovative aspects, in combination with DFOS and AI/LLM, provide—in sharp contrast to the prior art—an interactive AI/LLM-driven set of solutions fused with fiber optic sensing technologies that effortlessly identify optical fiber cable anomalies in real-time, thereby mitigating optical fiber cable damage and providing real-time reports on maintenance activities on infrastructure facilities—including communications—and services built thereupon.

As we shall show and describe, advantageous features of a DFOS system including AI/LLM according to aspects of the present disclosure include: i) Pioneering live-updated database for LLM systems; ii) Groundbreaking LLM system designed specifically for telecommunications networks; iii) Real-time response facilitation between field operations and infrastructure; iv) Comprehensive reporting capabilities—daily, weekly, monthly, and yearly—to aid operators in network health monitoring; vi) Intelligent event-based recommendations for preventing fiber damage; and vii) Proactive suggestions derived from historical data for preemptive disaster prevention.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative motivational diagram for our inventive systems and methods according to aspects of the present disclosure.

FIG. 3 is a schematic diagram showing illustrative architecture features and relationships or sequences of operation of systems and methods according to aspects of the present disclosure.

FIG. 4 is a schematic diagram of an illustrative Live CQ interface display according to aspects of the present invention.

FIG. 5 is a schematic diagram of an illustrative Live CQ interface display showing pinpoint tickets on a map according to aspects of the present disclosure.

FIG. 6 is a schematic diagram of an illustrative Live CQ interface display showing a pinpointed event on a map according to aspects of the present disclosure.

FIG. 7 is a schematic diagram of an illustrative Live AQ interface display according to aspects of the present disclosure.

FIG. 8 is a schematic diagram of an illustrative Live AQ interface display showing a selection routes/date screen according to aspects of the present disclosure.

FIG. 9 is a schematic diagram of an illustrative Live AQ interface display showing pinpoint events on a map according to aspects of the present disclosure.

FIG. 10 is a schematic diagram of an illustrative Live IQ interface display according to aspects of the present disclosure.

FIG. 11 is a schematic diagram of an illustrative Live IQ interface display showing results of detected highest temperature according to aspects of the present disclosure.

FIG. 12 is a schematic diagram of an illustrative Live IQ interface display showing results of temperature visualization according to aspects of the present disclosure.

FIG. 13 is a schematic block diagram of an illustrative DFOS system employing AI/LLM according to aspects of the present disclosure.

FIG. 14 is a schematic flow diagram of illustrative features including sensing, generative GPT/LLM architecture, and field technician/operator actions according to aspects of the present disclosure.

FIG. 15 is a series of plots commonly plotted for a period of time along locations from 0 to 8000 m indicating temperature at the respective location for an illustrative report generated by systems and methods according to aspects of the present disclosure.

FIG. 16 is a series of plots showing Temperatures in Memphis for an illustrative report generated by systems and methods according to aspects of the present disclosure.

FIG. 17(A) and FIG. 17(B) are show event occurrences at 8.36 km and 12.2 km respectively in tabular form for an illustrative report generated by systems and methods according to aspects of the present disclosure.

FIG. 18 is a schematic of an illustrative map showing a detected anomaly event at 8.36 km for an illustrative report generated by systems and methods according to aspects of the present disclosure.

FIG. 19 shows a pair of waterfall plots of an example of received signal (30-min duration) and an example of received signal (1-min duration) for detected anomaly events at 8.36 km for an illustrative report generated by systems and methods according to aspects of the present disclosure.

FIG. 20 is a schematic of an illustrative computer system that may be employed in systems and methods according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

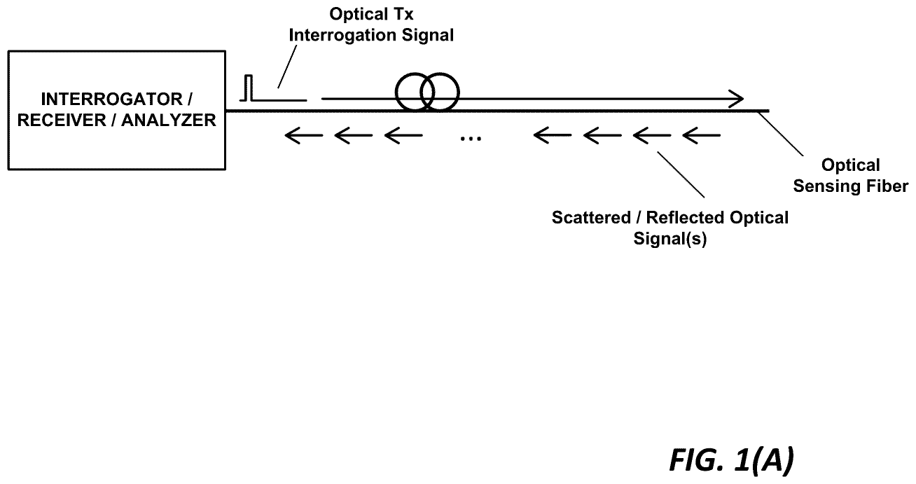

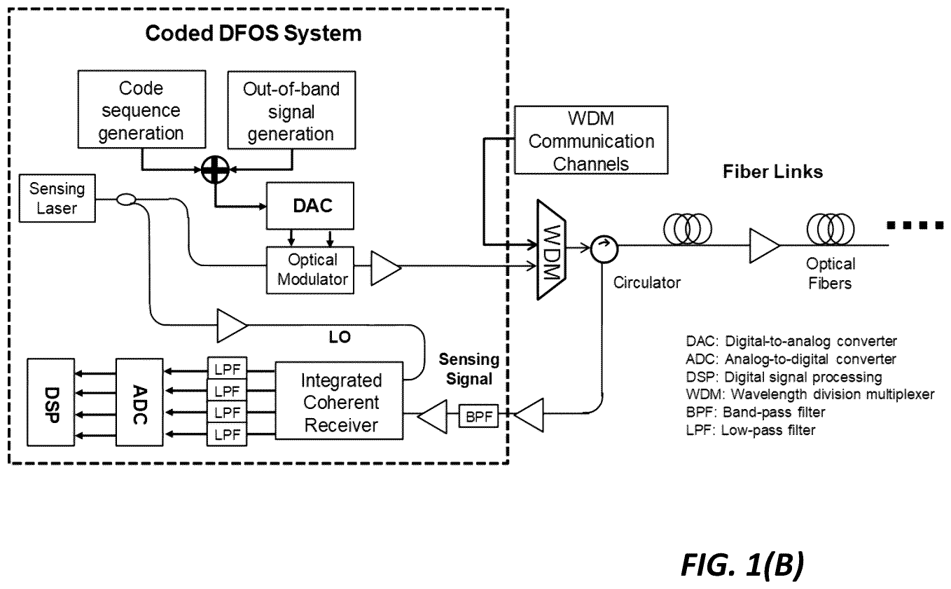

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed temperature sensing systems (DTS) are optoelectronic devices and system which measure temperatures by means of an optical fiber functioning as linear temperature sensors. Temperatures are recorded along the optical sensor cable, thus not at points, but as a continuous profile. A high accuracy of temperature determination may be achieved over great distances.

Typically, contemporary DTS systems can locate the temperature to a spatial resolution of 1 m with accuracy to within ±1° C. at a resolution of 0.01° C. Measurement distances of greater than 30 km can be monitored and some specialized DTS systems can provide even tighter spatial resolutions. Thermal changes along the optical sensor fiber cause a local variation in the refractive index, which in turn leads to the inelastic scattering of the light propagating through it. Heat is held in the form of molecular or lattice vibrations in the material.

Molecular vibrations at high frequencies (10 THz) may be responsible for Raman scattering. Low frequency vibrations (10-30 GHz) may cause Brillouin scattering. Energy is exchanged between the light travelling through the optical sensor fiber and the material itself thereby causing a frequency shift in the incident light. This frequency shift can then be used to measure temperature changes along the fiber.

Physical measurements, such as temperature or pressure and tensile forces, can affect glass fibers and locally change the characteristics of light transmission in the fiber. As a result of the damping of the light in the glass fibers through scattering, the location of an external physical effect can be determined so that the optical fiber can be employed as a linear sensor.

Optical fibers are generally made from doped quartz glass. Quartz glass is a form silicon dioxide (SiO₂) with amorphous solid structure. Thermal effects induce lattice oscillations within the solid.

When light falls onto these thermally excited molecular oscillations, an interaction occurs between the light and the electrons of the molecule. Light scattering, also known as Raman scattering, occurs in the optical fiber. Unlike incident light, this scattered light undergoes a spectral shift by an amount equivalent to the resonance frequency of the lattice oscillation. The light scattered back from the fiber optic therefore contains three different spectral shares: the Rayleigh scattering with the wavelength of the laser source used, the Stokes line components from photons shifted to longer wavelength (lower frequency), and the anti-Stokes line components with photons shifted to shorter wavelength (higher frequency) than the Rayleigh scattering.

The intensity of the so-called anti-Stokes band is temperature-dependent, while the so-called Stokes band is practically independent of temperature. The local temperature of the optical fiber is derived from the ratio of the anti-Stokes and Stokes light intensities.

There are two basic principles of measurement for distributed fiber optic sensing technology, Optical Time-Domain Reflectometry (OTDR) and Optical Frequency-Domain Reflectometry (OFDR). For distributed temperature sensing often a code correlation technology is employed which carries elements from both principles.

OTDR has become the industry standard for telecom loss measurements which detects the—compared to Raman signal very dominant—Rayleigh backscattering signals. The principle for OTDR is quite simple and is very similar to the time-of-flight measurement used for radar.

Essentially a narrow pulse of laser light generated either by semiconductor or solid-state lasers is introduced into the optical sensing fiber and backscattered light is analyzed. From the time it takes the backscattered light to return to a detection unit it is possible to locate the location of the temperature event.

Alternative DTS evaluation units deploy the method of Optical Frequency Domain Reflectometry—OFDR. The OFDR system provides information on the local characteristic only when the backscatter signal detected during the entire measurement time is measured as a function of frequency in a complex fashion and then subjected to Fourier transformation. The essential principles of OFDR technology are the quasi-continuous wave mode employed by the laser and the narrow-band detection of the optical backscatter signal. This is offset by the technically difficult measurement of the Raman scattered light and rather complex signal processing, due to the FFT calculation with higher linearity requirements for the electronic components.

Code Correlation DTS sends on/off sequences of limited length into the fiber. The codes are chosen to have suitable properties, e.g. binary Golay code. In contrast to OTDR technology, optical energy is spread over a code rather than packed into a single pulse. Thus, a light source with lower peak power compared to OTDR technology can be used, e.g. long-life compact semiconductor lasers. The detected backscatter needs to be transformed—like OFDR technology—back into a spatial profile, e.g. by cross-correlation. In contrast to OFDR technology, the emission is finite (for example 128 bit) which avoids that weak scattered signals from far are superposed by strong scattered signals from short distance, improving the Shot noise and the signal-to-noise ratio.

Using these techniques it is possible to analyse distances of greater than 30 km from one system and to measure temperature resolutions of less than 0.01° C.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DTS/DAS/DVS technologies have a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

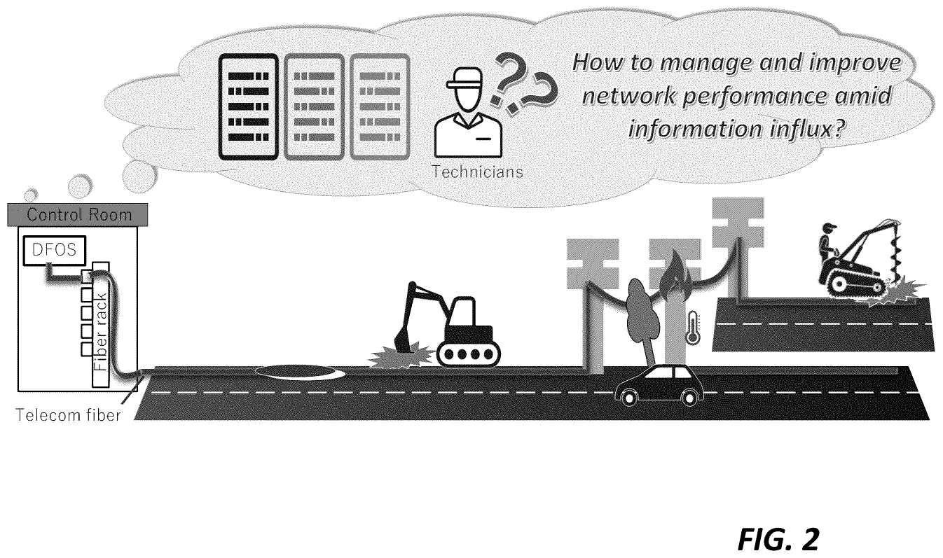

FIG. 2 is a schematic diagram showing an illustrative motivational diagram for our inventive systems and methods according to aspects of the present disclosure. FIG. 2 encapsulates the driving force behind our inventive systems and methods according to aspects of the present disclosure. With an increasing inclination towards utilizing fiber sensing within real-world applications, leveraging existing telecommunications facilities as a sensing medium generates a substantial influx of field data via fiber sensors. Effectively managing this voluminous information becomes crucial for carriers and operators. As a solution, the proposed architecture stands as an effective tool, aiding carriers and operators in efficiently handling, processing, and disseminating reports on a daily, weekly, monthly, and yearly basis, streamlining information management processes

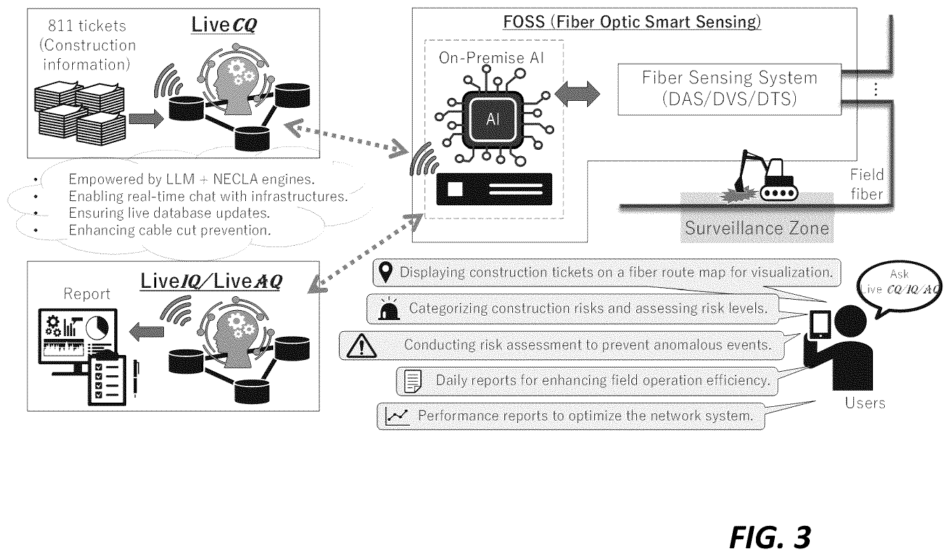

FIG. 3 is a schematic diagram showing illustrative architecture features and relationships or sequences of operation of systems and methods according to aspects of the present disclosure. As illustratively shown in that figure, one may observe the several components of our inventive generative Artificial Intelligence/Large Language Model (AI/LLM) architecture including:

Live CQ (Construction Query)—Live CQ functions as an advanced engine meticulously examining all construction activities near a monitored fiber optic cable, leveraging data received from 811 tickets via email. Subsequently, an on-premises AI engine within the Fiber Optic Smart Sensing (FOSS) system establishes surveillance zones to closely monitor the fiber optic cable, aiming to prevent any potential damage. Upon receiving these tickets, the AI engine extracts pertinent construction details such as type, location, and duration of work. It then precisely identifies and marks the construction along the monitored cable route. If the construction aligns closely with the monitored fiber optic cable, the event is pinpointed on a Live CQ map. Conversely, if the construction doesn't affect the monitored fiber optic cable, the 811 ticket is disregarded.

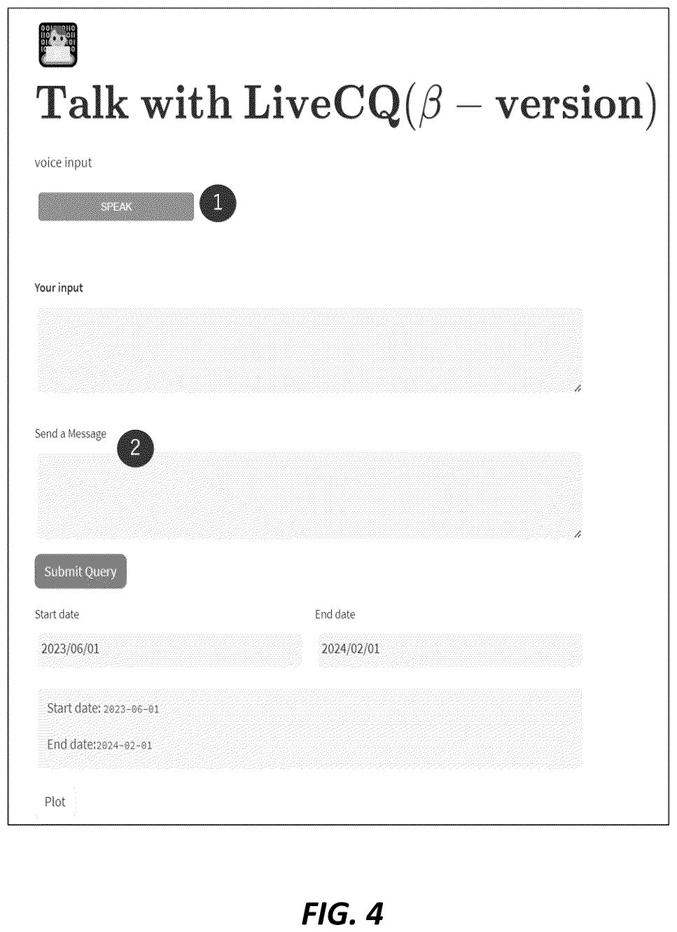

FIG. 4 is a schematic diagram of an illustrative Live CQ interface display according to aspects of the present invention.

The Live CQ interface, accessible through a web-based server, enables seamless user interaction with the engine via smart devices or computers using natural language. The interface offers two primary functions for inquiries: \textcircled{1} speech-based input and \textcircled{2} text-based messaging, facilitating intuitive communication with the system through “Submit Query”.

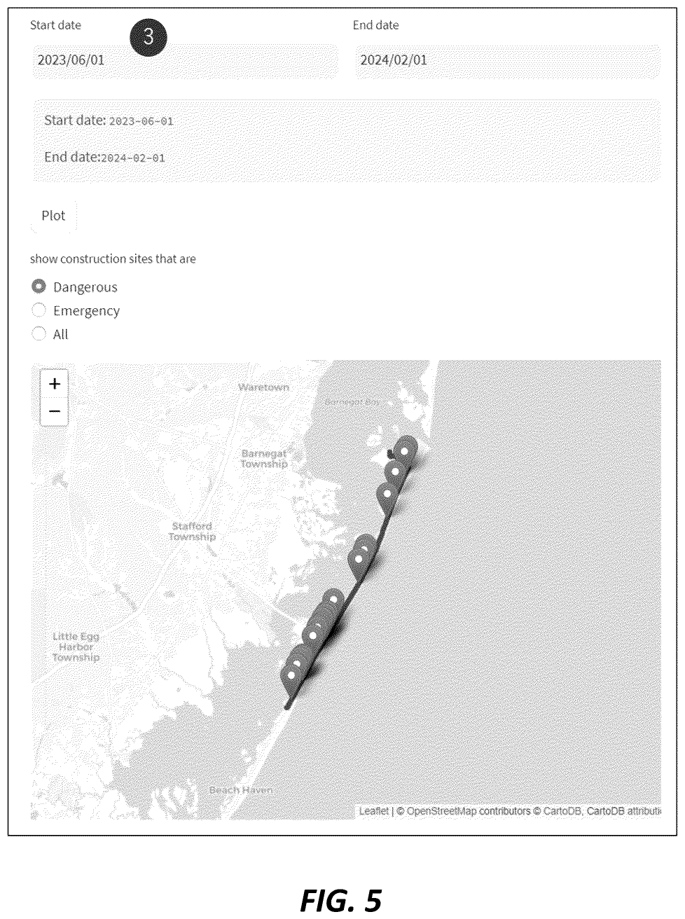

FIG. 5 is a schematic diagram of an illustrative Live CQ interface display showing pinpoint tickets on a map according to aspects of the present disclosure.

As illustratively shown, the specific events detected in proximity to the monitoring cable (indicated by the line) during the chosen timeframe are illustrated. At point \textcircled{3}, users have the option to specify the start and end dates to review constructions identified by 811 tickets. The Live CQ engine disregards constructions not aligned with the monitoring cable. Furthermore, Live CQ provides the option to filter and display tickets categorized as Dangerous, Emergency, or all tickets.

Dangerous tickets are categorized as construction activities occurring within a 5-meter radius of the cable, determined by GPS coordinates. These activities are deemed critical, such as pipeline repair, with a construction depth exceeding 2 meters. Emergency tickets, on the other hand, are identified as those requiring immediate repair based on the information provided by the 811-ticket system.

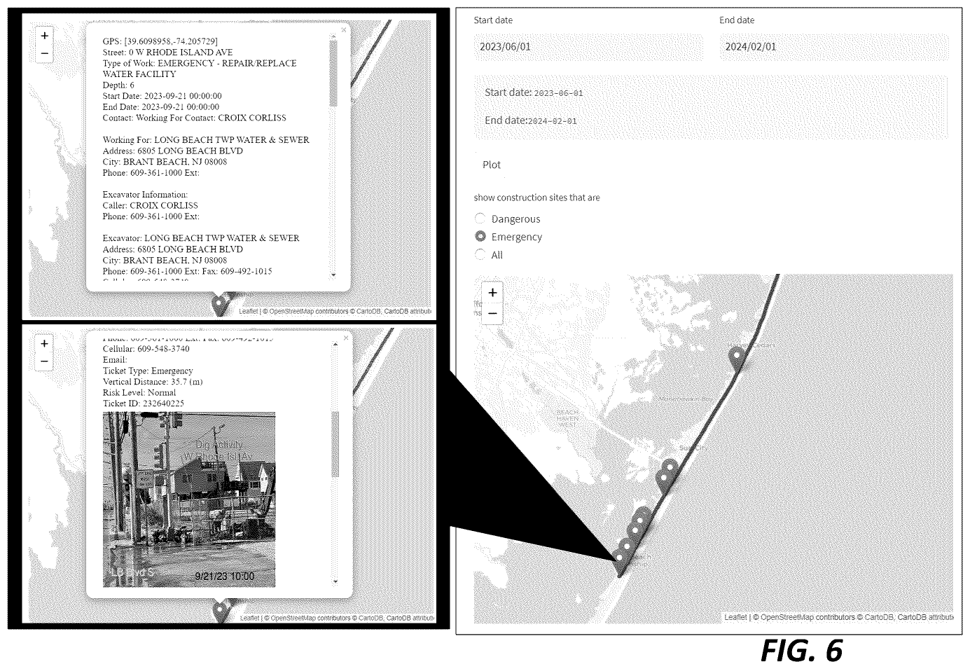

When clicking (selecting) on the pinpointed event on the map, it will display detailed construction information as shown in FIG. 6, which is a schematic diagram of an illustrative Live CQ interface display showing a pinpointed event on a map according to aspects of the present disclosure.

This includes all relevant details from the 811 tickets, such as construction type and contact person phone numbers. Additionally, Live CQ will define the vertical distance between the construction and the cable, along with determining the risk level. Moreover, the interface will offer a comprehensive street view of the vicinity surrounding the construction site, enhancing the visual experience for users.

Live AQ—Live AQ functions as an engine specifically crafted to showcase detected anomaly events along monitoring routes, utilizing fiber sensing technologies. It continuously updates the LLM system in real-time, encompassing a comprehensive database that comprises historical event logs as well as the most recently detected anomalies.

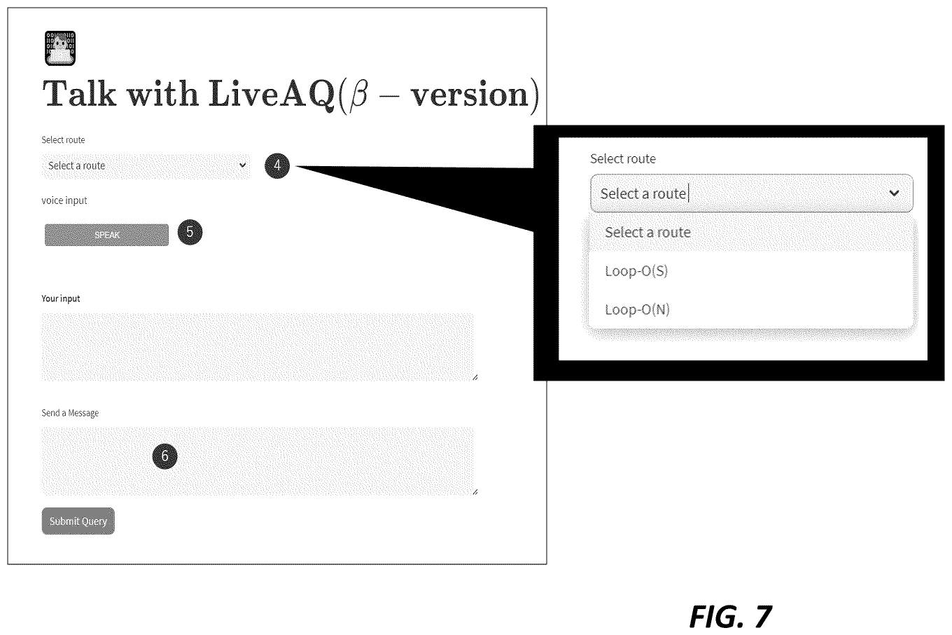

FIG. 7 is a schematic diagram of an illustrative Live AQ interface display according to aspects of the present disclosure. FIG. 7 showcases the Live AQ interface, accessible through a web-based server, allowing seamless user interaction with the engine via smart devices or computers, using natural language. Prior to posing a query, users are required to select their preferred route of interest, marked as point \textcircled{4} in FIG. 7. The interface provides two main inquiry options, mirroring Live IQ: \textcircled{5} speech-based input and \textcircled{6} text-based messaging, enabling intuitive communication with the system through the ‘Submit Query’ feature.

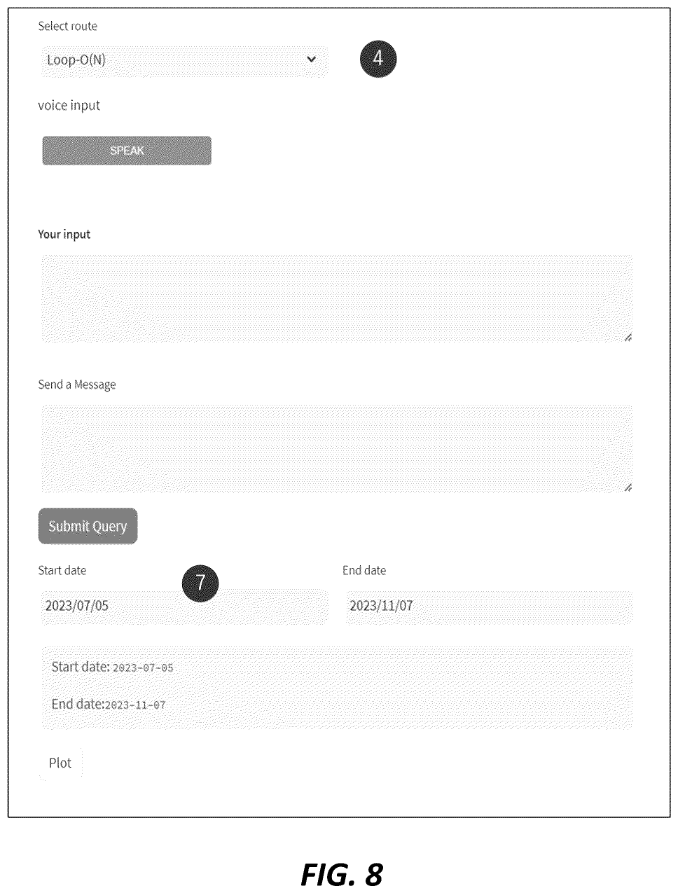

FIG. 8 is a schematic diagram of an illustrative Live AQ interface display showing a selection routes/date screen according to aspects of the present disclosure.

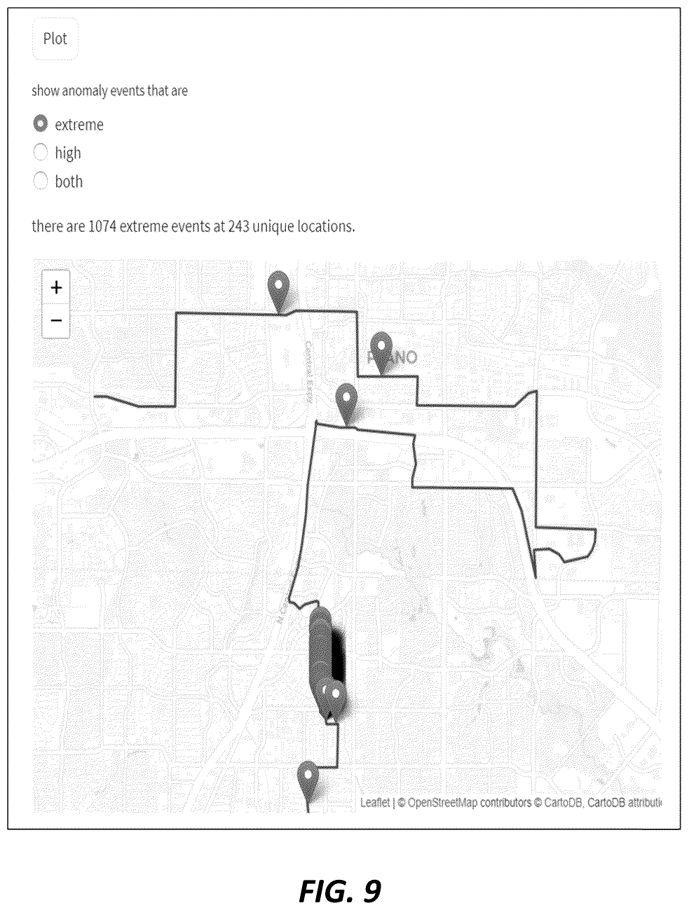

FIG. 9 is a schematic diagram of an illustrative Live AQ interface display showing pinpoint events on a map according to aspects of the present disclosure.

Once the route is chosen at point \textcircled{4} (e.g., Loop-O(N)) followed by the selection of the monitoring period at point \textcircled{7} in FIG. 8, the identified events will be showcased on a map, as depicted in FIG. 9. This display will encompass the total count of extreme, high, or both types of events along with their respective location counts for further analyzing.

Live IQ—Live IQ functions as a real-time engine presenting current route conditions. It establishes a direct connection to the fiber sensor, analyzing the sensing data in real-time. This system consistently updates the LLM database with the received sensing data, ensuring a comprehensive repository that includes both real-time and historical data.

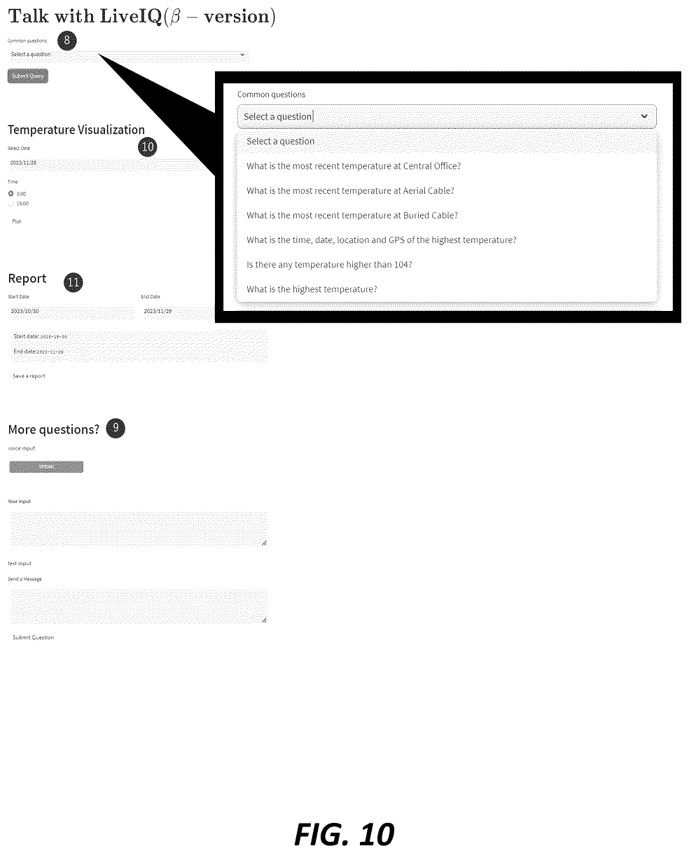

FIG. 10 is a schematic diagram of an illustrative Live IQ interface display according to aspects of the present disclosure.

Displayed in FIG. 10, the Live IQ interface, utilizing DTS as an example, is accessible through a web-based server. This interface enables effortless user engagement with the engine via smart devices or computers, employing natural language. At point \textcircled{8}, Live IQ offers several standard inquiries (common questions) for users, such as ‘What is the most recent temperature at Central Office?’. With this function, remote monitoring the temperature inside the CO can be realized. Naturally, these predefined queries can be tailored and customized according to specific requirements.

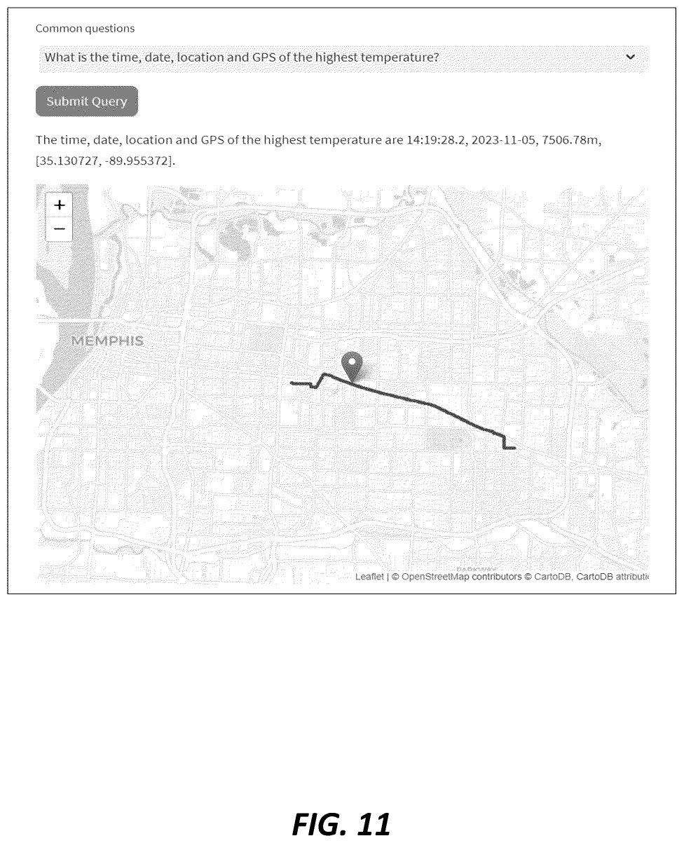

FIG. 11 is a schematic diagram of an illustrative Live IQ interface display showing results of detected highest temperature according to aspects of the present disclosure.

Within FIG. 11, an example is depicted where a user selects the query ‘What is the time, date, location, and GPS coordinates of the highest temperature?’ from the common questions. Live IQ promptly furnishes the results by retrieving the relevant data from the database, including the date and time, fiber length, and GPS coordinates. Furthermore, it pinpoints the specific location on a map, with the monitoring fiber route highlighted in red.” Furthermore, at point 9, users have the flexibility to ask additional questions simply by speaking or typing.

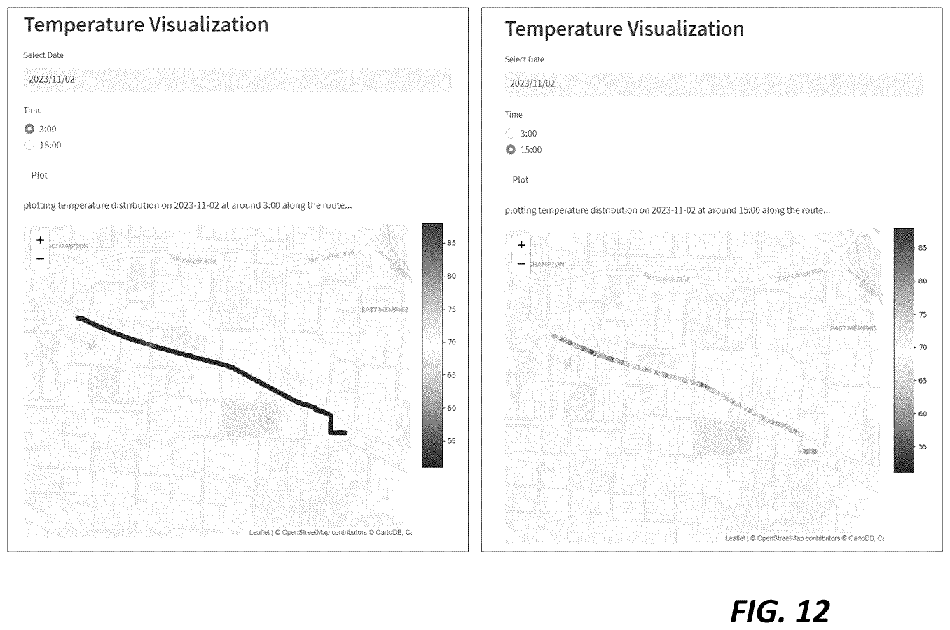

FIG. 12 is a schematic diagram of an illustrative Live IQ interface display showing results of temperature visualization according to aspects of the present disclosure. FIG. 12 exhibits the temperature visualization outcomes accessible when users select the data at point \textcircled{10} in FIG. 10. As illustratively shown, users have the option to choose between two time slots: 3 AM and 3 PM. Upon clicking ‘Plot,’ the temperature readings along the entire route are displayed, as illustrated in FIG. 12. This functionality enhances the visual features, enabling users to swiftly observe temperature variations across the route.

At point \textcircled{11} in FIG. 10, there exists a function for generating reports that offer a quick summary of anomalies detected along the monitoring route. By selecting the ‘start date’ and ‘end date’ and proceeding to ‘save a report’ and ‘Export_Report,’ a detailed report for the specified period is generated and available for download in a PDF format.

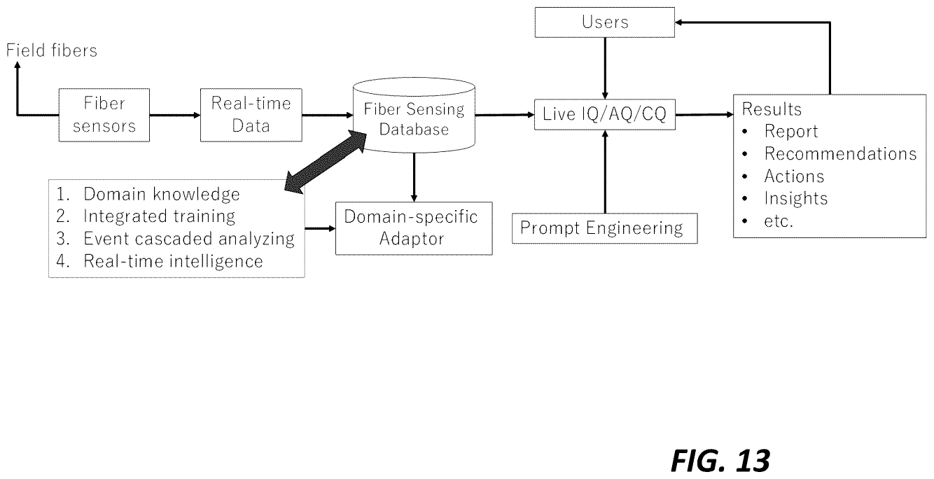

FIG. 13 is a schematic block diagram of an illustrative DFOS system employing AI/LLM according to aspects of the present disclosure.

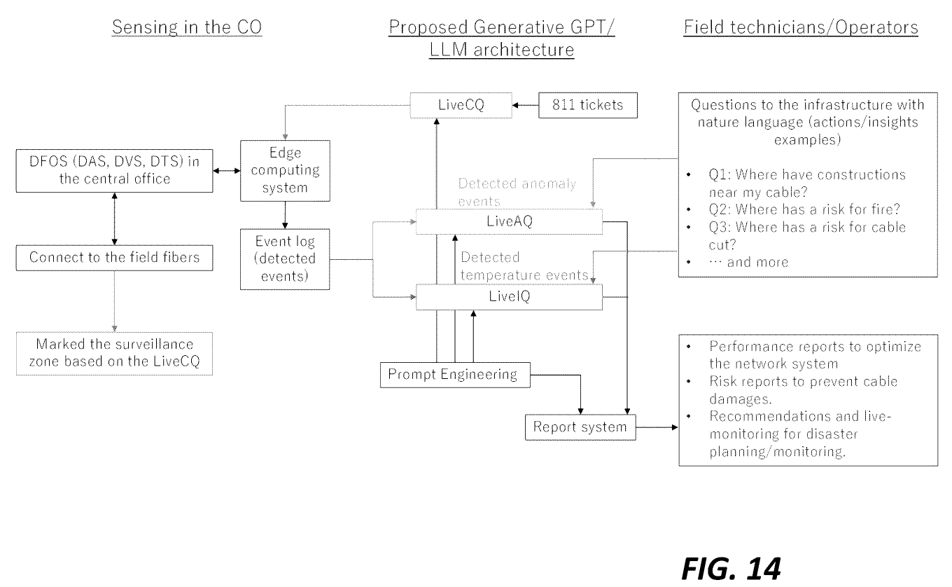

FIG. 14 is a schematic flow diagram of illustrative features including sensing, generative GPT/LLM architecture, and field technician/operator actions according to aspects of the present disclosure.

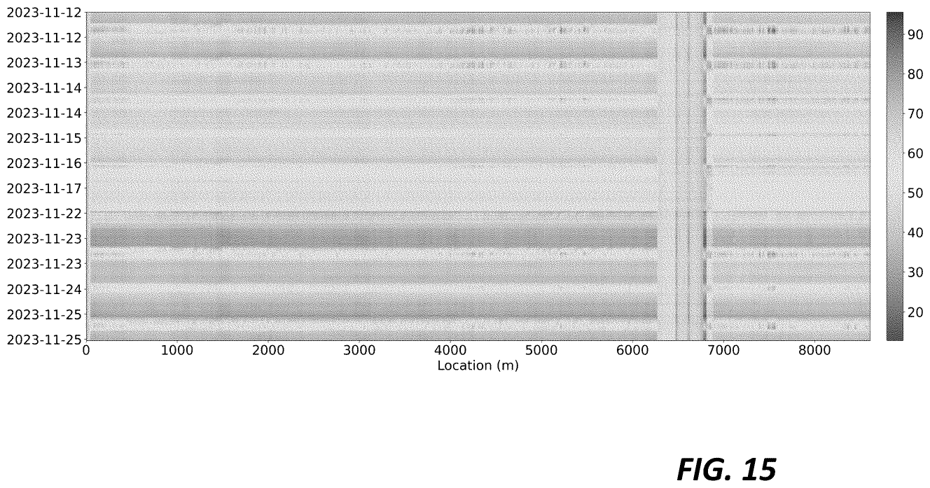

Examples of the type of illustrative information that may be provided in reports generated by systems and methods according to the present disclosure may include those illustratively shown in FIGS. 15-19.

FIG. 15 is a series of plots commonly plotted for a period of time along locations from 0 to 8000 m indicating temperature at the respective location for an illustrative report generated by systems and methods according to aspects of the present disclosure.

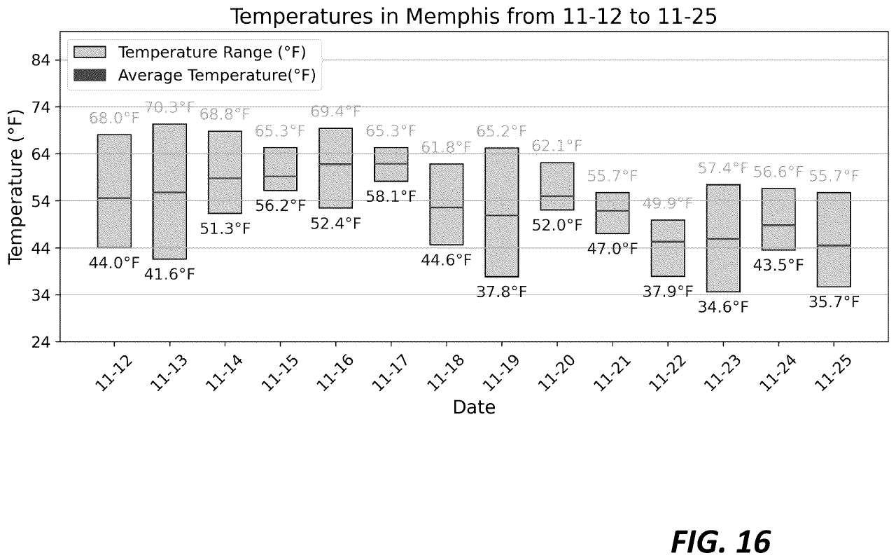

FIG. 16 is a series of plots showing Temperatures in Memphis for an illustrative report generated by systems and methods according to aspects of the present disclosure.

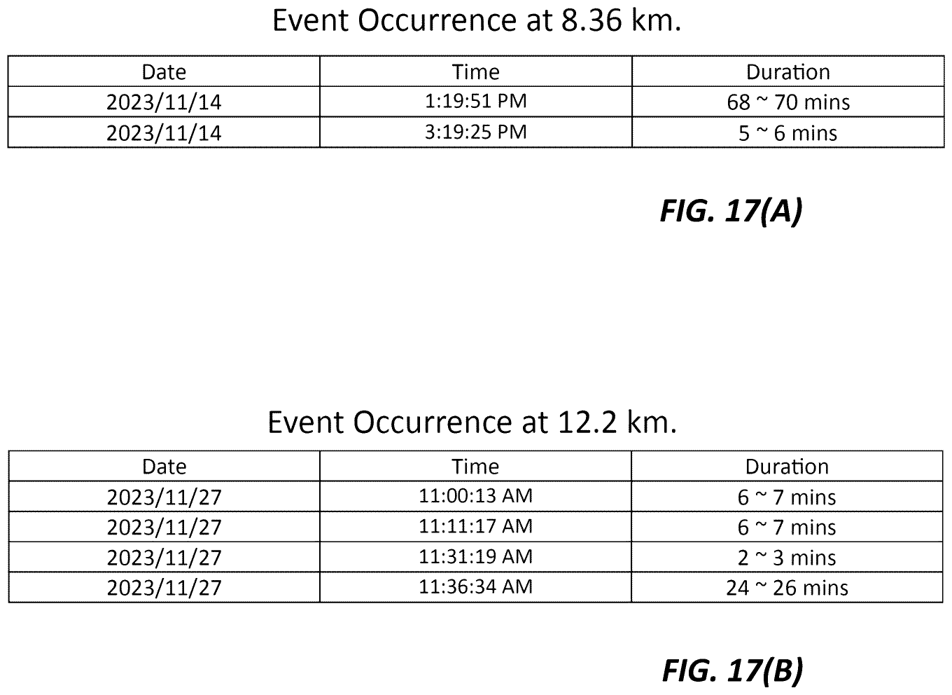

FIG. 17(A) and FIG. 17(B) are show event occurrences at 8.36 km and 12.2 km respectively in tabular form for an illustrative report generated by systems and methods according to aspects of the present disclosure.

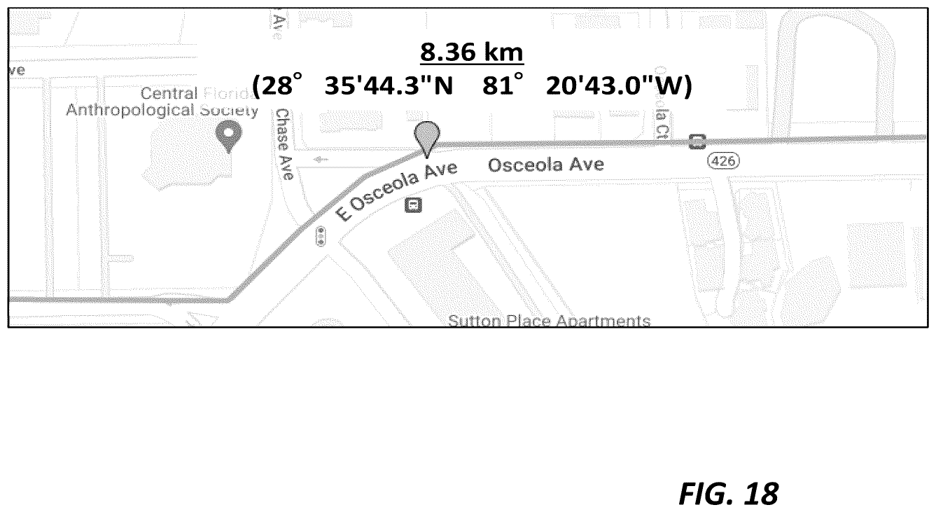

FIG. 18 is a schematic of an illustrative map showing a detected anomaly event at 8.36 km for an illustrative report generated by systems and methods according to aspects of the present disclosure.

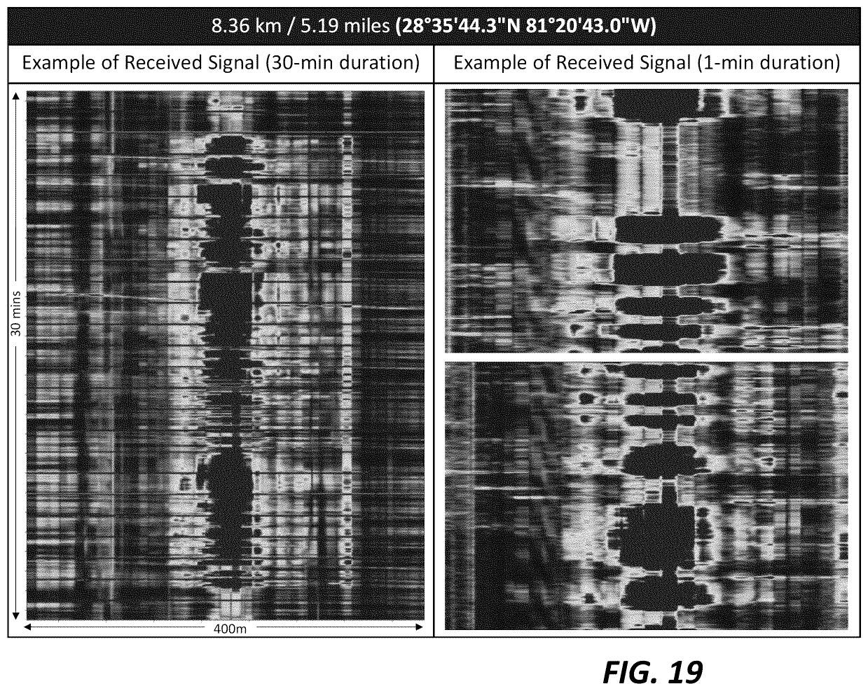

FIG. 19 shows a pair of waterfall plots of an example of received signal (30-min duration) and an example of received signal (1-min duration) for detected anomaly events at 8.36 km for an illustrative report generated by systems and methods according to aspects of the present disclosure.

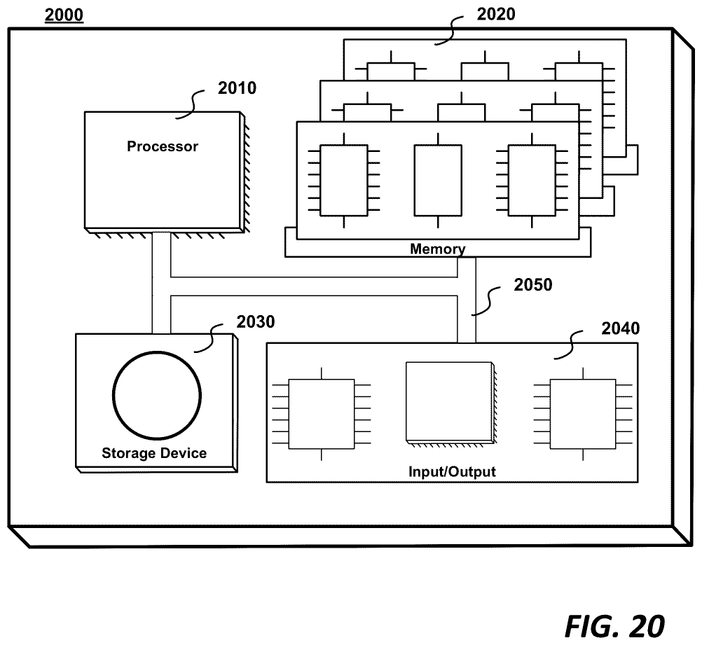

FIG. 20 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 2000 as stored program control instructions.

Computer system 2000 includes processor 2010, memory 2020, storage device 2030, and input/output structure 2040. One or more input/output devices may include a display 2045. One or more busses 2050 typically interconnect the components, 2010, 2020, 2030, and 2040. Processor 2010 may be a single or multi core. Additionally, the system may include accelerators etc., further comprising the system on a chip.

Processor 2010 executes instructions in which embodiments of the present disclosure may comprise steps described in one or more of the Drawing figures. Such instructions may be stored in memory 2020 or storage device 2030. Data and/or information may be received and output using one or more input/output devices.

Memory 2020 may store data and may be a computer-readable medium, such as volatile or non-volatile memory. Storage device 2030 may provide storage for system 2000 including for example, the previously described methods. In various aspects, storage device 2030 may be a flash memory device, a disk drive, an optical disk device, or a tape device employing magnetic, optical, or other recording technologies.

Input/output structures 2040 may provide input/output operations for system 2000.

As those skilled in the art will readily appreciate, benefits of our inventive systems and methods and interactive processes include at least the following.

Efficient Query Resolution: Our systems and methods with LLM are able to understand natural language, technicians/operators can efficiently address various user queries and issues, potentially reducing the need for users to visit physical stores or contact human representatives for assistance.

24/7 Availability: Our systems and methods provide around-the-clock availability, providing continuous support and information to users without constraints related to human availability.

Enhanced Network Performance: Our systems and methods provide daily/weekly/monthly/yearly reporting on the monitoring routes to discover any anomalies and find solutions to solve the issue.

Personalized Assistance: Our systems and methods provide personalized assistance to users, offering tailored recommendations, troubleshooting steps, and service suggestions based on individual needs.

While we have presented our inventive concepts and description using specific examples, our invention is not so limited. Accordingly, the scope of our invention should be considered in view of the following claims.

1. An interactive distributed fiber optic sensing system comprising:
the distributed fiber optic sensing (DFOS) system including generative Artificial Intelligence and Large Language Models (AI/LLM), the DFOS system configured to monitor, capture, and analyze one or more of temperature, acoustic, strain, and vibration data of a fiber optic network; and
wherein in response to user input and based on captured and analyzed data of the fiber optic network, the DFOS system is configured to provide live construction query and response (Live CQ) information, live anomaly query and response (Live AQ) information, and live inquiry query and response (Live IQ) information.

2. The system of claim 1 wherein the Live CQ information includes information about construction activities near the fiber optic network monitored by the DFOS system.

3. The system of claim 2 wherein the Live AQ information includes information about anomaly events along the fiber optic network monitored by the DFOS and the DFOS system is configured to continuously update the large language models (LLM) with Live AQ information.

4. The system of claim 3 wherein the Live IQ information includes information about current route conditions along the fiber optic network monitored by the DFOS and the DFOS system is configured to continuously update the LLM with the Live IQ information.

5. The system of claim 4 wherein the DFOS system, based on trouble tickets (811 tickets) received, is configured is configured to establish surveillance zones at one or more locations along the fiber optic network.

6. The system of claim 5 wherein the LLM is continuously updated with Live AQ information comprises historical event logs and most recently detected anomalies.

7. The system of claim 6 wherein the LLM is continuously updated with the one or more of temperature, acoustic, strain, and vibration data of the fiber optic network.

8. The system of claim 7 wherein the DFOS, based on the 811 tickets received, is configured to extract construction details including type, location, and duration of construction activities and identify and mark the extracted details on a map of the fiber optic network.

9. The system of claim 8, wherein the DFOS is configured to allow a user interaction via smart devices or computers, using natural language.

10. The system of claim 9, wherein the Live CQ, Live AQ, and Live IQ information is available to a user through a world wide web interface using a natural language of the user.
